(19) United States
(12) Patent Application Publication
(10) Pub. No.: US 2013/0123564 A1
(43) Pub. Date: May 16, 2013

(54) Method and System for Stabilizing Volatile Radionuclides During Denitration at High Temperatures

(71) Applicant: J. Bradley Mason, Donnelly, ID (US)

(72) Inventor: J. Bradley Mason, Donnelly, ID (US)

(21) Appl. No.: 13/297,548

(22) Filed: Nov. 16, 2011

(51) Int. Cl. A62D 3/37

(52) U.S. Cl. 588/319

(57) ABSTRACT

Providing a method for eliminating NOₓ from an input waste form, including waste forms with volatile elements. The method includes adding the input waste form, reducing additives, a fluidizing gas, and mineralizing additives to a fluidized bed reactor. The reactor includes multiple portions and at least one portion is operated in a reducing atmosphere. The bed is operated at temperatures greater than 800° C.

### FIELD OF THE INVENTION

The present invention relates generally to a single step process for removing NOₓ compounds from waste products, compounds and wastewaters with the resulting waste form having suitable leach resistance properties while limiting the release of volatile elements during processing. More specifically, the invention relates to a single step process utilizing a fluidized bed contactor to remove NOₓ compounds from explosive, hazardous and/or radioactive materials at high temperatures while providing a final waste form with suitable leach resistance properties.

### BACKGROUND OF THE INVENTION

Nitrogen oxides can be commonly found in many waste products and compounds. Nitrogen oxides (referred to herein as “NOₓ”) include such compounds as nitric acid, aluminum nitrate, sodium nitrate, ammonium nitrate, potassium nitrate, nitrites, and the like.

Traditional approaches to removing NOₓ include dry contact reduction processes for solid and gaseous nitrate compounds and wet absorption processes for gaseous NOₓ. Dry contact reduction processes may be either catalytic or non-catalytic and may be either selective or non-selective. Selective reduction processes are characterized by the selective reduction of gaseous nitrogen oxides and their consequent removal in the presence of oxygen. A common selective reduction agent for gaseous NOₓ is ammonia. Ammonia, however, oxidizes to form unwanted nitrogen oxide at high temperatures. Moreover, excess ammonia is itself a pollutant. Other selective reduction methods employ catalysts such as iridium. The problem with catalyst reduction is that the presence of particulates, sulfurous acid gases and other poisons reduce catalyst effectiveness and life thereby increasing costs.

Non-selective reduction processes generally involve the addition of a reducing agent to the gaseous NOₓ containing material, consuming all free oxygen through combustion and reducing the NOₓ to nitrogen by the remaining reducing agent. Catalysts are typically utilized in these processes. Reducing agents and catalysts useful in these processes are both scarce and expensive.

Wet absorption processes typically require large and expensive equipment such as absorption towers. An example of a wet absorption process is the absorption of nitrogen oxides by water or alkali solution. Another shortcoming of the wet absorption process is that these methods are not economically effective where the NOₓ concentration in the gaseous waste stream is above 5,000 ppm.

In the nuclear industry, there is an annual production of significant amounts of wastes which are classified as radioactively contaminated salt cakes, ion exchange media, sludges and solvents. These radioactive wastes either contain nitrogen oxides or nitrogen oxides are produced as part of the treatment of these wastes. In particular, nuclear fuel reprocessing with nitric acid produces highly radioactive nitric acid and sodium nitrate waste by-products.

For solid or slurry NOₓ wastes and compounds a variety of processes have been tried for NOₓ destruction. Rotary calciner and fluid bed processors have been utilized with typical results yielding less than 90% conversion of solid nitrates to gaseous NOₓ and nitrogen. The gaseous NOₓ generally exceeded 10,000 ppm which requires addition of extensive gaseous NOₓ removal methods as described above. In addition, severe agglomerations occur in processors as well as the presence of flammable or explosive mixtures of nitrates and reducing agents in the processors.

Another problem associated with prior art waste processing methods involves sulfur containing compounds. The presence of such sulfur compounds in a vitrification melter can cause a molten sulfur salt pool to accumulate on top of the molten inorganic residue (glass); this pool causes high corrosion rates for the melter equipment. The pool can also have a high electrical conductivity, which causes short-circuiting of the heating electrodes in the melter. Additionally, potentially explosive conditions can result if large quantities of water contact the molten sulfur salt pool.

Further, the presence of heavy metals in the inorganic residues can render the final waste product hazardous, thereby requiring additional processing of the residue before disposal or higher disposal costs. Also, the inorganic residue can contain soluble components that may form aqueous solutions after processing; these solutions can result in contamination of the surroundings after disposal.

A process which does not have the limitations and shortcomings of the above described prior art methods for nitrogen oxide removal from waste streams and compounds would be highly desirable.

### SUMMARY OF THE INVENTION

According to its major aspects and briefly recited, the present invention is a method and apparatus for converting nitrogen oxides directly to nitrogen using a single steam-reformer vessel at temperatures of 800 degrees Centigrade and higher. Nitrate compounds or wastes are fed into the single vessel along with a fluidized gas composed of steam and, optionally, oxygen. The single vessel contains an inert media bed made of high-density media, such as amorphous alumina beads up to 3000 microns in diameter. The fluidizing gases are injected at relatively high speeds, ranging up to 800 feet per second.

In one aspect of the present invention, a method for removing nitrogen oxides is provided. The method includes the steps of (in no particular order): (1) providing liquids, slurries, sludges or solid waste material containing the nitrogen oxides; (2) providing a fluidized bed reaction vessel containing a reaction bed having a lower portion, a middle portion, and an upper portion; (3) heating the fluidized bed reaction vessel to an operating temperature greater than 800° C.; and (3) adding a fluidizing gas, a reductant, a mineralizing additive, and the waste material into the fluidized bed reaction vessel reaction bed, where the fluidizing gas is injected at a velocity that agitates the waste material and elutriates fine solids from the reaction bed; and (4) operating at least the lower portion of the reaction bed under strongly reducing conditions sufficient to achieve low leaching of elements from the final waste form and to destroy substantially all of the nitrogen oxides in the waste material.

In another aspect of the present invention, the method recited above further includes the step of co-injecting oxygen with the superheated steam into the lower portion such that the lower portion of the reaction bed operates under more oxidizing than strongly reducing conditions but overall still reducing conditions.

In another aspect of the present invention, the method recited above further includes the step of injecting oxygen into the upper portion such that the upper portion operates under more oxidizing but overall still reducing conditions.

In another aspect of the present invention, the method recited above further includes the step of injecting oxygen into the upper portion such that the upper portion operates under fully oxidizing conditions

In another aspect of the present invention, the method recited above further includes the step of injecting oxygen into the middle portion such that the middle portion operates under more oxidizing but overall still reducing conditions.

In another aspect of the present invention, the method recited above where when the waste material contains sulfur, chloride, fluoride, or iodide compounds, the mineral additive is selected from the group consisting of clays, zeolite, silica gel, silica, silicates, phosphate compounds, calcium compounds, magnesium compounds, titanium compounds, iron compounds, and aluminum compounds.

In another aspect of the present invention, the method recited above where the reaction bed is comprised of inert beads.

In another aspect of the present invention, the method recited above where the reducing conditions are sufficient to destroy substantially all of the nitrogen oxides in the waste material.

In another aspect of the present invention, the method recited above where fluidizing gas comprises one of more of steam, oxygen, hydrogen, methane, carbon dioxide, carbon monoxide, hydrocarbon vapors, nitrogen, and ammonia.

In another aspect of the present invention, the method recited above where the mineralizing additive is selected from the group consisting of clays, zeolite, silica gel, silica, silicates, phosphate compounds, calcium compounds, magnesium compounds, titanium compounds, iron compounds, and aluminum compounds.

In another aspect of the present invention, the method recited above where the maximum operating temperature equals the minimum melt temperature of the waste form resulting from the method.

In another aspect of the present invention, the method recited above further includes the step of injecting at least one co-reactant into the reaction vessel reaction bed to enhance the reduction of the nitrogen oxides.

In another aspect of the present invention, the method recited above where the co-reactant is selected from the group consisting of solid carbonaceous material, soluble carbonaceous material, gaseous carbonaceous compounds, hydrogen, ammonia, and metal compounds.

In another aspect of the present invention, the method recited above where the metal compounds are selected from the group consisting of iron compounds, nickel compounds, copper compounds, and cobalt compounds.

In another aspect of the present invention, the method recited above further includes the step of injecting at least one additive into the reaction vessel reaction bed to form higher melting point alkali metal and alkaline earth compounds.

Another aspect of the present invention, the method recited above where the additive is mixed with the input waste prior to injection of the waste into the reaction vessel reaction bed.

### BRIEF DESCRIPTION OF THE DRAWINGS

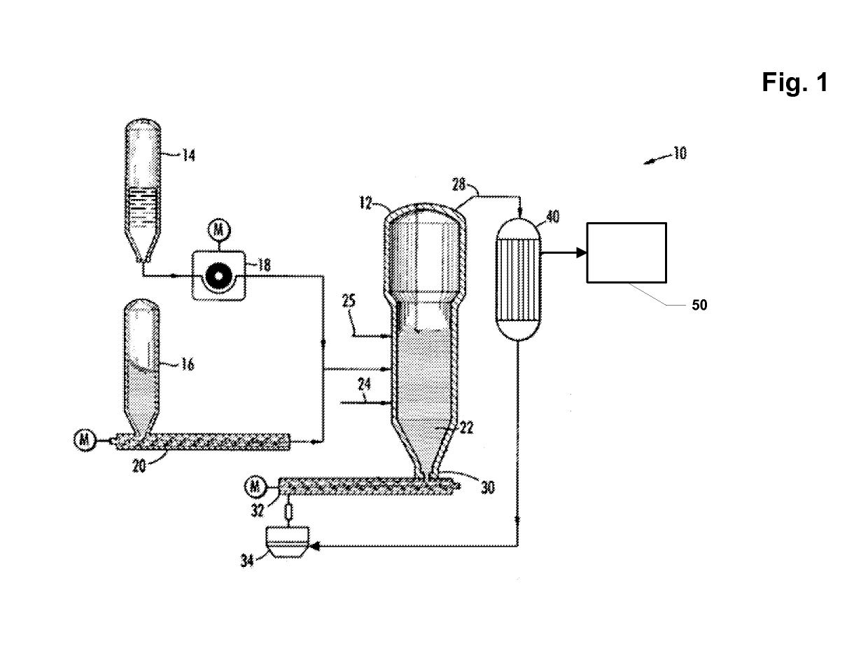

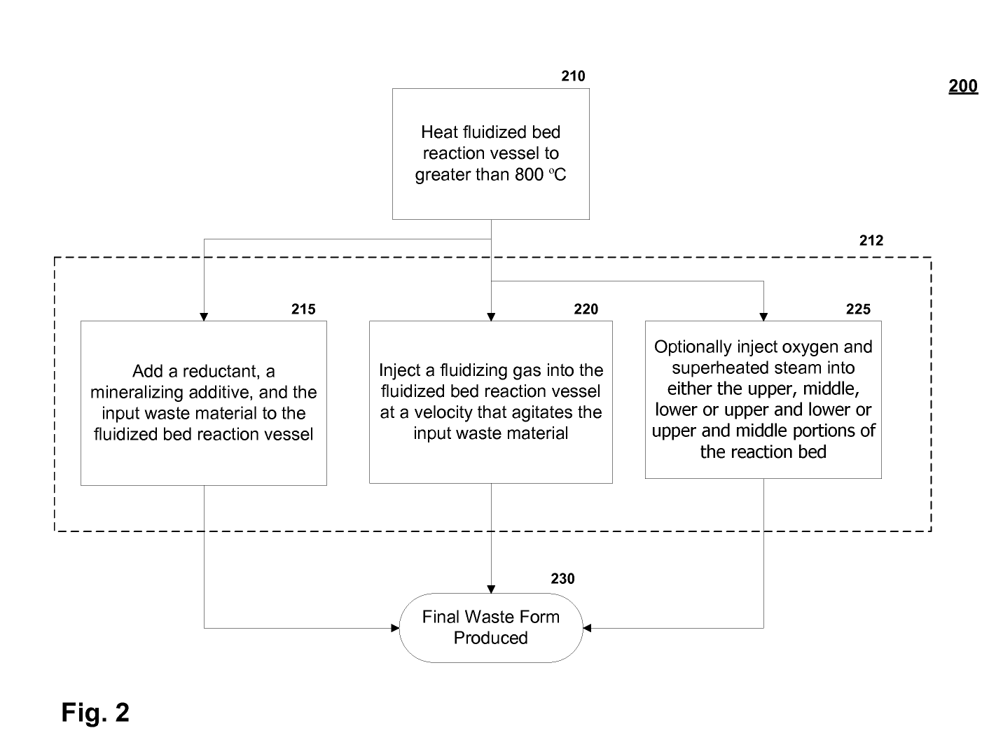

In the drawings, FIG. 1 is a schematic illustration of a system for removing NOₓ from a waste stream or compound according to a preferred embodiment of the present invention. FIG. 2 provides an exemplary process.

### DETAILED DESCRIPTION OF PREFERRED EMBODIMENTS

The present invention is an apparatus and process for removing NOₓ from nitrate bearing compounds and waste product feeds while producing a final waste product with suitable leaching properties and further limiting the release of volatile elements during processing. The present apparatus and processes will be described in particular with respect to radioactive waste but any nitrogen oxide containing waste or product stream can be processed in accordance with the following process and with the components of the system.

The process is based on a single fluidized bed reactor vessel using steam for fluidizing which may be operated under strongly reducing conditions or under strongly reducing conditions in combination with oxidizing conditions. Other fluidizing gases or additives may be utilized to modify the oxidizing or reducing conditions in the reactor. Typical other fluidizing gases include: hydrogen, oxygen and/or air (when more or fully oxidizing conditions are desired), methane, other organic vapors, carbon dioxide, carbon monoxide, ammonia, etc. Other additives can be added such as charcoal, carbonaceous materials, sugars, hydrogen peroxide, etc. to further modify reducing or oxidizing conditions in the bed. The wastes that can be processed according to the present invention include not only NOₓ containing waste streams resulting from the decomposition of ion exchange resins, but also NOₓ containing waste stream resulting from nuclear reprocessing, explosives and energetics, fertilizer and gaseous off-gas streams and the like.

Referring now to FIG. 1, there is shown a system according to the present invention and generally indicated by reference number 10. System 10 includes a single reactor vessel 12. Waste feed, which may be comprised of liquid slurries and sludges 14 and/or solids 16, are fed into the reactor vessel 12. In the case of the liquid slurries and sludges 14, a pneumatic pump, peristaltic pump or progressive cavity 18 may be employed for delivery of the pumpable fluids to the reactor vessel 12. In the case of the solids 16, a screw auger 20 may be employed to deliver the solid waste stream into the reactor vessel 12.

In reactor vessel 12, inert or reactive media 22 is used in the fluid bed. Media 22 is preferably an inert material which may serve as a heat sink such as silica, sintered clay-like materials, or alumina beads, most preferably, amorphous alumina beads at least 100 and preferably 250 to 600 1000 microns in diameter, however beads up to 5,000 microns in diameter can be utilized. Such size beads do not easily elutriate out of the vessel and therefore minimize carryover. Another advantage of the amorphous alumina or sintered clay is that it will not form eutectic salt/glasses that can form harmful agglomerates that affect reactor efficiency as when common silica sand is utilized. The amorphous alumina and sintered clay are also exceptionally strong and hard and resists attrition due to bed friction and impact.

In order to evaporate water present in the waste feeds and to serve as a heat source, charcoal, coal, sugar and/or other carbonaceous materials are added to reactor vessel 12, optionally other reductants or catalysts such as iron or nickel oxalates, oxides, or nitrates may be used. Reaction bed materials can be modified to include these, or other metals, in order to further improve the denitration process. For example, the addition of 2 to 5% iron oxide to the reaction bed medium can improve NOₓ reduction by more than two-fold and serves to bind heavy metals, such as Cr and Ni, into water insoluble spinels. Fluidizing medium (gases) is introduced into reaction vessel 12 via inlet 24. Steam is preferred to combustion gases as the fluidizing medium because it is more reactive, and generates CO and H₂ that are highly reducing by steam reformation of carbonaceous materials. Gaseous NOₓ compounds can be co-injected with the fluidizing gases through inlet 24.

The heat generated by the reaction of the carbonaceous and/or other reducing gases with the nitrogen oxides and/or oxygen input allows the reaction vessel to be operated at the temperature required for reduction of the nitrogen oxides. This method of internal heat generation provides autothermal temperature control in the bed. The present method, for example, converts sulfates such as Na₂SO₄ by mineralization into non-volatile sulfur compounds such as nosean or calcium sulfate. By mineralizing the sulfur the presence of corrosive sulfur gases, such as H₂S, are minimized, which reduced system corrosion to acceptable levels. Halogen gases, Cl, F, and I, are similarly mineralized into non-volatile mineral compounds such as sodalite and calcium chloride, calcium fluoride, etc.

The fluidizing medium can be an inert gas, but is preferably a reforming gas and may have oxygen present. Most preferably, the medium is superheated steam. The fluidizing velocity can range from about 0.5 feet per second or higher depending on the bed media, preferably 0.8 to 1.5 feet per second (FPS) depending upon the size of the bed media. Fluidizing gas distributors are designed to provide higher than normal gas/orifice velocities. Typical gas distributor velocities are 100 to 200 FPS, however, gas velocities can range from 20 to 800 FPS.

The high fluidizing gas jet speed has several advantages. High velocity fluidizing gas jets in a vertically oriented bed provides jet impingement on the media to help break down the softer, friable feed and to break-up agglomerates. Moreover, the media beads become self-cleaning due to abrasion in the high impact area around the fluidizing gas distributor.

Reactor vessel 12 is preferably operated in elutriating mode. Sodium salts and other low melting eutectic salts are thereby present in only low concentration (less than 2%) and are quickly carried out of the bed. The media beads are self-cleaning through abrasion. The low inventory of unconverted nitrates or sodium compounds greatly minimizes agglomeration potential. Alternatively, the bed may consist of accumulated granular mineral product solids such that no separate bed media is used.

As discussed above, the reactor vessel 12 may be operated using one of four methods, in the first method, the lower portion of the media bed is operated under more oxidizing conditions. To achieve this condition oxygen is mixed with the steam and introduced into the reactor vessel 12 via inlet 24 and may be optionally superheated. The pressure in the reactor vessel 12 is preferably about 13 to 15 psia. The reactor vessel 12 is preferably operated at greater than 800 degrees centigrade. The media bed depth is preferably between about 3 to 8 feet, expanded. The middle portion of media bed in reactor vessel 12 is operated under strongly reducing conditions, and the upper portion of the media bed is operated under more oxidizing conditions by the addition of oxygen enriched air or air or oxygen mixed with nitrogen via inlet 25. Temperature is maintained within reactor vessel 12 by adjusting the level of oxygen input to the bed and/or by super heating fluidizing gases which provides auxiliary energy as needed, particularly during start-up. When the NOₓ has been reduced to nitrogen, the nitrogen, steam and other syn gases leave the reaction vessel 12 via port 28. Small sized reformed residues, including entrained particulates also leave via port 28. Heavier solids leave via port 30 and are carried away by screw auger 32 to product collector 34. Auger 32 is preferably gas cooled. From collector 34 the solids may be directed to stabilization process or disposal or storage, not shown.

The nitrogen gas, steam, other syn gas and fine particulates pass through filter 40. Any non-gaseous residue or particulates collected in the filter 40 is directed to product collector 34. The filtered gases from the filter 40 are then treated by conventional means in an unspecified off treatment system 50.

Under the conditions of method 1 set forth above, the process treatment results in final gaseous effluent very low in NOₓ with no CO and H₂ output. The system generally requires low auxiliary energy addition. This system does not require the removal of NOₓ in the off gas treatment system as NOₓ levels exiting the reactor 12 are routinely <25 ppm. The addition of a thermal oxidizer in the offgas treatment system is also not required.

Alternatively and in a second method of the invention, the lower portion of the media bed in reactor vessel 12 may be operated under more oxidizing conditions, as discussed above, the middle portion and the upper portions of the media bed are operated under strongly reducing conditions. Method 2 results in lowered NOₓ exiting reactor 12 as compared to method 1 but has increased levels of CO and H₂ and other trace volatile organics in the reactor 12 output. Additional auxiliary energy is generally needed in the reactor 12 and the offgas treatment system will require a thermal oxidizer.

In method 3, the reactor vessel 12 is operated only under strongly reducing conditions. Method 3 results in lowered NOₓ, increased CO and H₂ and requires increased autothermal energy and use of a thermal oxidizer in the offgas treatment system.

In method 4, only the upper portion of the reactor vessel 12 media bed is operated under more or fully oxidizing conditions. Method 4 results in low NOₓ, no CO and H₂ output and increased auxiliary energy. The offgas treatment system thermal oxidizer is not required in the practice of this method.

Notably, gaseous NOₓ can also be processed by direct introduction to reactor 12 with other waste feeds. For example, high NOₓ offgas from a vitrification melter or thermal denitration process can be used as both the waste stream and the fluidizing gas; however, steam is co-injected to keep the total gas flow through the reaction bed at greater than 20% steam and to provide uniform fluidizing gas velocities.

Testing has demonstrated the usefulness of metal additions to the bed to facilitate NOₓ reduction and stabilization of heavy metals into non-hazardous metal spinels. Metal additives are not always required but are useful in maximizing NOₓ conversion to nitrogen gas. Typical metals that can be used include copper, cobalt, iron or nickel oxalate or nitrates that can be co-injected with the waste feed in concentrations of less than 0.5%. For heavy metal mineralization into spinels iron based additives can be added to the bed as particulates or in the waste feed as fine particulates or as soluble iron.

The addition of charcoal, coal or carbonaceous solids to the bed in sizes ranging up to 0.75 inches in diameter is unique to the preferred embodiment. The large particles of carbon maintain a constant inventory of carbon that is not possible with typical fine sugars, organic solids or liquids or liquid chemicals previously used to facilitate nitrate reduction. The presence of larger carbon solids together with addition of soluble carbon in the form of formic acid, sugars, etc. provides superior nitrate reductions. The presence of carbon compounds in the bed will produce highly reducing CO and H₂ in the bed via steam reformation.

Additionally, certain additives such as aluminum metal and phosphate salts or oxides can be added to form high melting point salts with alkaline earth elements. For example, sodium phosphate is a high melting point sodium salt compared with sodium eutectic salts that have relatively low temperature melting points. These combining elements help minimize formations of agglomerations in the bed. Additional additives that can combine with alkali metals include silica, silica gel, clays, calcium, magnesium, and titanium containing materials.

In the present method, sulfur and halogen containing waste with fluoride, chloride or iodine compounds can be mineralized into non-volatile mineral products by addition of mineralizing additives such as calcium, magnesium, clays, silicas, etc.

Further, the present method can use additives to tailor the solubility of the resulting inorganic residue. As discussed above, soluble components in the residue may form aqueous solutions that can result in contamination of the surroundings after disposal. An example of such tailoring of the solubility of the residue in the present method is the addition of aluminum nitrate or aluminum hydroxide to sodium-containing waste; in the correct proportions, this additive produces sodium-aluminum oxides that are insoluble in water. Preferably, the mineralizing additive can be clay that will convert the alkali metals into alkali-alumino-silicates that are highly water insoluble. Using clay the otherwise volatile sulfur, chlorine, fluorine, iodine can be converted into high melting point, water insoluble minerals such as the sodalite mineral, nosean, etc. By converting such soluble and volatile components into insoluble, nonvolatile mineralized derivatives, the present method avoids this problem that is traditionally associated with the reduction of nitrogen oxide-containing waste streams.

The above-described embodiments are not limited to an operating temperature of between 600° C. and 800° C. of other processes that may be limited because of the presence of volatile radioactive elements and other volatile chemical elements and compounds. For example, radioactive technetium (Tc) and cesium (Cs) are normally highly volatile in ordinary thermal treatment processes. However, by the addition of clay and other mineralizing additives such as alkali hydroxide (sodium hydroxide or equal) or in the presence of alkali nitrates the Tc and Cs can be mineralized into high melting, non-volatile sodalite minerals. One of ordinary skill in the art would expect that elements such as technetium and cesium, which may be present in certain radioactive wastes, would volatilize at temperatures above 800° C. For example, such volatilization is seen during the vitrification of radioactive waste (which occurs at temperatures greater than 800° C.), suggesting that the same volatilization would be seen for the process of the present invention.

The need arose to operate the above-described processes at higher temperatures to allow for complete oxidation of certain waste constituents within the fluidized bed reactor and to provide enhanced NOₓ reduction and process throughput rates. The present invention encountered unexpected results when the above-described embodiments were operated at temperatures greater than 800° C. Specifically, the expected volatilization did not occur when the input waste material was mineralized within the fluidized bed reactor. When the input waste is added to the fluidized bed reactor, either as a liquid slurry, sludge, or solid waste, along with mineralizing additives, such as clays, zeolite, silica gel, silica, silicates, phosphate compounds, calcium compounds, magnesium compounds, titanium compounds, iron compounds, and aluminum compounds, the input waste form converts, inside the reactor, to a mineralized form. This mineralized final waste form retains the volatile elements through the remaining treatment process. Other mineralizing additives that can be used to mineralize the input waste form include sodium silicate, sodium aluminate, sodium, hydroxide, sodium carbonate, calcium compounds, phosphates, magnesium compounds, magnesium/iron silicates, sodium magnesium/iron silicate phosphates, and still others, such as compounds where sodium is substituted by potassium or other alkali metals. Typically, the melt temperature of the mineralized waste form is greater than 1100° C., which represents the upper limit of temperature operation.

When operating at temperatures greater than 800° C., the amount of certain additives, such as charcoal or coal is increased as compared to the amount used when operating at temperatures between 600° C. and 800° C. to cause the reactor to run at a more reducing environment. This adjustment increases the leach resistance of the waste form resulting from the process. For example, certain elements, such as technetium, may change oxidation state such that they are more soluble in a final waste form generated at the higher (greater than 800° C.) temperatures as compared to a final waste form generated by the process at temperatures less than 800° C. Typically, a performance goal of a final waste form is to minimize the leach rate of certain elements, including radionuclides, so as to protect the surrounding environment. As such, the level of the reducing environment in the reactor is increased to produce a waste form with better leachability properties. This increased reducing atmosphere still did not increase the volatility of these elements at the higher temperatures. One of ordinary skill in the art would understand that a “more reducing environment” means more reducing as compared to the level necessary to convert the NOₓ present in the waste. Of course, the level of the reducing atmosphere can be (and likely will need to be) adjusted as necessary based on the input waste material and the desired properties of the resulting waste form. As such, for different input waste and desired final waste form properties, the reducing environment may be such that not all volatized NOₓ may be destroyed. To mitigate the need to potentially operate at less reducing, i.e. more oxidizing, conditions in the bed, the operating temperature may preferably be limited to less than 950° C. to reduce the potential formation of thermal generated NOₓ in the process when operating at greater than 800° C.

FIG. 2 illustrates an exemplary process 200. Referring to FIG. 2, at step 210, a fluidized bed reaction vessel with a reaction bed including a lower, middle, and upper portion is heated to an operating temperature greater than 800° C. Step 212, illustrated in FIG. 2 as a dashed box, represents the step of adding waste material and reactants into the fluidized bed reaction vessel. Step 212 can be broken into steps 215, 220, and 225, at substantially the same time. At step 215, a reductant, a mineralizing additive, and the input waste material are added into the middle portion of the fluidized bed reaction vessel reaction bed. The reductant, mineralizing additive, and input waste input waste containing NOₓ and volatile elements may be mixed together prior to being added to the fluidized bed reaction vessel. Alternatively, the mineralizing additive and input waste may be mixed prior to injecting the mixture into the fluidized bed reactor and the reductant added separately, although at substantially the same time as the mixture of the mineralizing additive and input waste. At substantially the same time as step 215, at step 220, a fluidizing gas, such as superheated steam, is injected into the fluidized bed reaction vessel at a velocity that agitates the input waste material and elutriates fine solids from the reaction bed. The fluidizing gas is injected into the bottom portion of the fluidized bed. The addition of the reductant causes at least the middle portion of the reaction bed to operate under strongly reducing conditions sufficient to achieve low leaching of elements from the final waste form.

At substantially the same time as steps 215 and 220, at step 225, oxygen and superheated steam may optionally be injected into any or all of the three portions of the reaction bed. When added to the lower portion of the reaction bed, the oxygen is included with the fluidizing gas. Alternatively (or additionally), oxygen can be added with air into the middle portion of the fluidized bed to atomize the waste input. Also, oxygen can alternatively (or additionally) be added with other diluting gas, such as nitrogen, into the upper portion of the fluidized bed. Oxygen added to the fluidized bed provides autothermal heat generation and temperature maintenance in the bed. The amount of oxygen input to the process can be adjusted to tailor the redox conditions in the bed from strongly reducing (no oxygen addition) to normal reducing, which is more oxidizing than “strongly reducing” but still reducing (there is no free oxygen, but there are lower levels of reducing gases), to fully oxidizing (where there is excess oxygen in the reactor). A final waste form is produced at step 230.

Possible input wastes, reductants, mineralizing additives, and fluidizing gases are as identified above for the different embodiments described herein.

### EXAMPLES

A series of bench-scale tests were run to generate final waste forms at varying operating conditions to determine the effect that the operating conditions have on properties of the final waste form. The operating conditions that were varied include: the operating bed temperature, coal ratio (the amount of coal used to create the reducing condition inside the bed to the amount of input waste material), and clay ratio (the amount of mineralizing additive needed for alkali metal mineralization to the amount of input waste material). The level of reducing conditions is a function of oxygen addition and the amount of reducing additives, in this case coal that is added. A higher coal ratio or addition rate produces stronger reducing conditions. At the end of each test run, the final waste form products were collected and leach-tested in water to determine the level of sodium (Na) and rhenium (Re) retention in the waste form product. The sodium level is used to measure the overall leach resistance of the waste form product solids and the rhenium level is used to measure the leach resistance of potentially volatile rhenium in the solids, a measure of the level of the reducing conditions or REDOx in the bed. In this way, the sodium and rhenium served as indicators for the leaching properties of other non-volatile and volatile elements and the REDOx conditions in the bed. Leach testing data for key test runs are listed in the table below.

| | | Bed | | | Re | Na |
|---|---|---|---|---|---|---|
| | Input | Temper- | | | Leach | Leach |
| | Waste Form | ature | Coal | Clay | Results | Results |
| Sample | Surrogate | (° C.) | Ratio | Ratio | % | % |
| FB-1B Bed | Std Clay, | 750 | 2.73 | 1.3 | 24.68% | 11.63% |
| | Std Coal | | | | | |
| FB-1B Filter | Std Clay, | 750 | 2.73 | 1.3 | — | — |
| | Std Coal | | | | | |
| FB-15 Bed | Std Clay, | 850 | 2.2 | 1.3 | 37.43% | 35.06% |
| | Std Coal | | | | | |
| FB-15 Filter | Std Clay, | 850 | 2.2 | 1.3 | 63.24% | 53.73% |
| | Std Coal | | | | | |
| FB-16 Bed | Std Clay, | 850 | 4.5 | 1.3 | 26.81% | 23.61% |
| | High Coal | | | | | |
| FB-16 Filter | Std Clay, | 850 | 4.5 | 1.3 | 55.21% | 17.75% |
| | High Coal | | | | | |

Several trends can be seen from the table. The test data show that waste form products generated at high temperatures are comparatively more leachable (FB-1B vs. FB-15). The data also shows that waste form products generated at higher coal ratio are comparatively more leach resistant (FB-15 vs. FB-16). Even at high temperatures, leach resistant mineral products can be generated if the coal ratio is appropriated increased, like in FB-16, which was an unexpected result as the opposite occurs at operating temperatures from 680 to 725° C., which is the operating temperature range where previous testing was performed.

These operational behaviors indicate that the coal ratio should be closely monitored and controlled during reactor operation where the coal ratio is controlled not to control NOₓ reduction but rather to achieve low volatile element leaching. Surprisingly, when the coal ratio is increased to much higher levels than used solely to reduce NOₓ to N₂, the low rhenium leach rate is maintained when operating at temperatures greater than 800° C.

It will be apparent to those skilled in the art of removing NOₓ from waste feeds that many modifications and substitutions can be made to the preferred embodiments described above without departing from the spirit and scope of the present invention, which is defined by the appended claims.

What is claimed:

1. A method for removing nitrogen oxides, comprising the steps of:
providing liquids, slurries, sludges or solid waste material containing the nitrogen oxides;
providing a fluidized bed reaction vessel containing a reaction bed having a lower portion, a middle portion, and an upper portion;
heating the fluidized bed reaction vessel to an operating temperature greater than 800° C.; and
adding a fluidizing gas, a reductant, a mineralizing additive, and the waste material into the fluidized bed reaction vessel reaction bed, wherein the fluidizing gas is injected at a velocity that agitates the waste material and elutriates fine solids from the reaction bed; and
operating at least the lower portion of the reaction bed under strongly reducing conditions sufficient to achieve low leaching of elements from the final waste form and to destroy substantially all of the nitrogen oxides in the waste material.

2. The method as recited in claim 1, further comprising the step of co-injecting oxygen with the superheated steam into the lower portion such that the lower portion of the reaction bed operates under more oxidizing than strongly reducing conditions but overall still reducing conditions.

3. The method as recited in claim 1, further comprising the step of injecting oxygen into the upper portion such that the upper portion operates under more oxidizing but overall still reducing conditions.

4. The method as recited in claim 1, further comprising the step of injecting oxygen into the upper portion such that the upper portion operates under fully oxidizing conditions.

5. The method as recited in claim 1, further comprising the step of injecting oxygen into the middle portion such that the middle portion operates under more oxidizing but overall still reducing conditions.

6. The method as recited in claim 1, wherein when the waste material contains sulfur, chloride, fluoride, or iodide compounds, the mineral additive is selected from the group consisting of clays, zeolite, silica gel, silica, silicates, phosphate compounds, calcium compounds, magnesium compounds, titanium compounds, iron compounds, and aluminum compounds.

7. The method as recited in claim 1, wherein the reaction bed is comprised of inert beads.

8. The method as recited in claim 1, wherein the reducing conditions are sufficient to destroy substantially all of the nitrogen oxides in the waste material.

9. The method as recited in claim 1, wherein the fluidizing gas comprises one of more of steam, oxygen, hydrogen, methane, carbon dioxide, carbon monoxide, hydrocarbon vapors, nitrogen, and ammonia.

10. The method as recited in claim 1, wherein the mineralizing additive is selected from the group consisting of clays, zeolite, silica gel, silica, silicates, phosphate compounds, calcium compounds, magnesium compounds, titanium compounds, iron compounds, and aluminum compounds.

11. The method as recited in claim 1, wherein the maximum operating temperature equals the minimum melt temperature of the waste form resulting from the method.

12. The method as recited in claim 1, further comprising the step of injecting at least one co-reactant into the reaction vessel reaction bed to enhance the reduction of the nitrogen oxides.

13. The method as recited in claim 12, wherein the co-reactant is selected from the group consisting of solid carbonaceous material, soluble carbonaceous material, gaseous carbonaceous compounds, hydrogen, ammonia, and metal compounds.

14. The method as recited in claim 13, wherein the metal compounds are selected from the group consisting of iron compounds, nickel compounds, copper compounds, and cobalt compounds.

15. The method as recited in claim 1, further comprising the step of injecting at least one additive into the reaction vessel reaction bed to form higher melting point alkali metal and alkaline earth compounds.

16. The method as recited in claim 15, wherein the additive is mixed with the input waste prior to injection of the waste into the reaction vessel reaction bed.
